(19) United States
(12) Patent Application Publication
(10) Pub. No.: US 2015/0049575 A1
(43) Pub. Date: Feb. 19, 2015

(54) METHOD AND AN APPARATUS FOR MIXING CHEMICALS HAVING OPPOSITE ELECTRIC CHARGES INTO A PROCESS LIQUID FLOW

(71) Applicant: WETEND TECHNOLOGIES OY, Savonlinna (FI)

(72) Inventors: Jouni Matula, Savonlinna (FI); Jussi Matula, Savonlinna (FI); Jari Makinen, Jamsa (FI)

(73) Assignee: WETEND TECHNOLGIES OY, Savonlinna (FI)

(21) Appl. No.: 14/388,631

(22) PCT Filed: Mar. 25, 2013
(86) PCT No.: PCT/FI2013/050327

§ 371 Date: Sep. 26, 2014

(30) Foreign Application Priority Data
Mar. 26, 2012 (FI) 20125338

(51) Int. Cl. B01F 3/08; B01F 15/02; B01F 5/04

(52) U.S. Cl. CPC B01F 3/0865; B01F 3/0803; B01F 5/04; B01F 15/0254; B01F 2215/0036
USPC 366/173.1

(57) ABSTRACT

A method including: introducing a first chemical to a first passage of a mixing apparatus attached to the process liquid flow pipe; introducing an injection liquid into a second passage of the mixing apparatus; introducing to a third passage of the mixing apparatus a second chemical having an electrical charge opposite to the electric charge of the first chemical; injecting the first chemical into the injection liquid by passing the first chemical through a passage between the first passage and the second passage; introducing the mixture of the first chemical and the injection liquid to a process liquid flowing through the process liquid flow pipe, and introducing the second chemical from the third passage to the process liquid in the process liquid flow pipe, wherein the second chemical passes from the third passage to the process liquid a distance from the injection of the first chemical into the injection liquid.

### TECHNICAL FIELD

The present invention relates to a method of and an apparatus for mixing chemicals having opposite electric charges into a process liquid flow. The method and the apparatus of the present invention are, thus, well applicable in mixing such chemicals to a process liquid flow that either react rapidly with each other, bond to one another or have an effect on the operation of each other. In accordance with an advantageous embodiment of the present invention, the method and the apparatus are applicable, for example, in pulp and paper making industry for mixing pulp processing or paper making chemicals, like for instance retention chemicals having opposite electric charges into a fiber suspension flow.

### BACKGROUND ART

Naturally, there is practically an innumerable amount of prior art methods of mixing various chemicals into liquid flows. However, these methods may be divided into a few main categories as can be seen from the following. Firstly, it is quite possible to just let the liquid to be added flow freely into a second liquid without using any special regulation or mixing means. This method of adding cannot be applied in situations where the mixing ratio or the uniformity of the mixing is important. Neither can it be applied in situations where the price of the chemical to be added is of significance. The next applicable method is to feed the chemical in a precise ratio to the liquid flow, whereby correct and economical dosage is obtained. However, even in this case one has to take into account that usually the dosage of the chemical is slightly excessive compared to the optimal dosage, because the mixing is known to be inadequate. The mixing may be improved, though, by feeding the chemical e.g. through a perforated wall of a flow channel, whereby at least the chemical to be mixed has a chance to spread throughout the entire liquid flow. However, with flow pipes having a diameter of tens of centimeters uniform mixing in this manner is, in practice, impossible. As the last example, a situation may be discussed, where the chemical is fed in a precise proportion either into the liquid flow upstream of the mixer or through the mixer itself. In such a case, the efficiency of the mixing of the chemical into the liquid flow is totally dependent on the mixer design.

FI-B1-108802 discusses the mixing of a chemical into fiber suspension flow flowing towards the head box of a paper machine. In accordance with the Finnish patent the mixing device is in fact a conical nozzle with an inlet for the chemical. An important and novel feature of the mixing device was that it was capable of injecting a chemical deep into the fiber suspension flow by using a non-clean liquid as the feeding liquid. The chemical and the feeding liquid contacted substantially simultaneously with their introduction into the fiber suspension flow. The idea behind this arrangement was to ensure that the chemical cannot harmfully react with the solids in the feeding liquid, as the chemical and the feeding liquid were not efficiently mixed together, whereby, for instance, the same fiber suspension in which the chemical was to be introduced could be used as the feeding liquid.

The injection mixers of FI-B1-108802 have been used for feeding chemicals having opposite electric charges to the paper machine approach flow system such that a first chemical is introduced, for instance, soon after the headbox screen and a second chemical having an opposite charge in relation to the first chemical at least 1.5 meters, preferably more than 2 meters, downstream of the first chemical, and the first injection mixer or mixer station. By means of the mentioned distance it has been ensured that the first chemical is well spread and mixed all over the flow prior to the introduction of the second chemical. Thus it has been also ensured that the chemicals do not adhere or bond to each other immediately after their introduction, but they have been given time to bond, for instance, to solids, i.e. fibers and other particulates before attracting the chemical having an opposite charge.

WO-A1-2006008333 discusses a further development of the above, in FI-B1-108802, discussed injection mixer. The injection mixer of WO-A1-2006008333 is capable of introducing several chemicals into a process liquid flow via the same unit and by using the same feeding liquid. This prior art injection mixer has three concentric openings at the level of the wall of the process liquid flow pipe. The innermost opening is for a mixing liquid, the annular opening in the middle is for a first chemical, and the outermost annular opening is for the feeding liquid. The document teaches that the injection mixer may be used to introduce a second chemical, and possibly a third chemical, into the fiber suspension by means of adding the chemical/s in the mixing liquid or/and in the feeding liquid. However, this means that the additional chemical/s has/have to be mixed with the mixing liquid or the feeding liquid before the introduction of the respective liquid/s to the injection mixer.

DE-A1-10 2010 028 573 is another document disclosing the use of an injection mixer for introducing one or more chemicals into a process liquid flow. The DE document discusses an injection mixer designed for solving the problem concerning scaling in the area of the injection. The formation of scaling on the surfaces of the injection mixer and the wall of the flow channel are prevented by injecting the chemical/s in the process liquid at a distance from the wall of the process liquid flow channel. It is clear that this kind of injection of chemical/s reduces the formation of scaling. However, as the injection of the chemical/s takes place transverse to the flow direction of the process liquid, i.e. in the same direction as the injection of the injection liquid, the concentration of the chemical/s, in the chemical jet, remains high. This kind of an injection of chemical/s parallel with the injection liquid is not efficient in any other respect but in view of preventing the formation of scaling on the surfaces of the mixer or of the flow channel. The DE document teaches that two chemicals may be introduced via the same injection mixer either such that they are introduced via two adjacent concentric pipes at different distances from the wall of the flow channel, via two adjacent flow channels having an injection liquid feed therebetween or via two adjacent flow channels at different distances from the wall of the flow channel and having an injection liquid feed therebetween. In each option the chemicals are fed in the direction of the injection liquid flow, whereby the chemicals are not efficiently mixed with the injection liquid, but their concentration in their jets remains high. This means, in practice, in case the chemicals are having opposite electric charges or otherwise attract each other, increased chances of the chemicals to meet soon after their injection. When the chemicals meet they are consumed in mutual reactions without having a chance to perform their desired task, for instance, improving the formation of flocs by binding solids to each other in order to improve the retention of solids on the paper machine wire.

Thus, it is clear that two chemicals having opposite electric charges cannot be introduced by means of any prior art single injection mixer. It is obvious that, if the injection mixer of WO-A1-2006008333 or DE-A1-10 2010 028 573 were used for feeding two chemicals having opposite electric charges, the chemicals find each other right after their introduction, and bond to each other losing their capability of any desired reactions with the particles in the fiber suspension. Thereby, it has been understood that the introduction of chemicals having opposite electric charges via the same injection mixer will result in
Reduced efficiency of the chemicals,
Changes in the properties of the intermediate or end products,
Increased chemical consumption, and
Formation of stickies and other undesired substances in the fiber suspension.

The reason for the above problems is that the concentration of the chemicals in the relatively compact (due to the requirement that the jet has to penetrate deep into the process liquid flow duct) discharge jet of the injection mixer is so high that the almost immediate contact of the chemicals having opposite electric charges within a single jet or within two parallel jets is inevitable. It has to be understood that, in an injection mixer, the combined volume flow of the feeding and mixing liquids (together with the chemicals) is a fraction (sometimes as low as a few percents) of the volume flow of the process liquid in which the chemicals are to be mixed. Thereby the concentration of the chemicals in the jet/s of chemicals discharged from the injection mixer may be tens of times higher than, after proper mixing, in the environment they are supposed to function. For the above reason such chemicals having opposite electric charges are nowadays mixed with the process liquid by means of two (or as many chemicals as there are) separate injection mixers or mixing stations (several injection mixers on the same circumference of the process liquid flow pipe) having a sufficient delay or distance therebetween. The purpose of the delay is that the first chemical has sufficient time to spread all over the cross section of the process liquid flow pipe and to be mixed efficiently (substantially evenly and uniformly) with the fiber suspension therein before the jet of the second chemical enters the flow pipe. Simultaneously the concentration of the first chemical is reduced (in a way, the chemical is diluted) to its functional range.

### BRIEF SUMMARY OF THE INVENTION

Thus, an object of the present invention is to develop a mixing method and a mixing apparatus that overcome at least some of the above discussed problems.

Another object of the present invention is to develop a mixing method and a mixing apparatus capable of mixing with process liquid chemicals having opposite electric charges such that the chemicals do not get into any substantial contact with each other until they have been efficiently mixed with the process liquid. This means, for example, that a first chemical has time to adhere to or react with a solid particulate in the suspension, and the second chemical having an opposite electric charge to or with another solid particulate, whereafter the two chemicals may meet and bond to one another such that the bonded particulate not only contains the chemicals but also the solid particulates of the suspension.

A further object of the present invention is to offer a simple and reliable injection mixer for feeding at least two chemicals having opposite electric charges into a process liquid.

In order to solve, among other things, the problem described above, a new chemical mixing apparatus has been developed the structure of which is very favorable in mixing chemicals having opposite electric charges into a process liquid flow. The injection mixing apparatus according to the invention includes a thin pipe-like duct disposed preferably inside the mixing apparatus, and extending therefrom deep into the process liquid flow pipe so that a desired chemical may be injected, separate from another chemical, evenly into the process liquid flow. If desired, several injection mixing apparatuses according to the invention instead of one may be arranged on the same circumference of the process liquid flow duct, whereby they may be called an injection mixing station.

As advantageous examples of the processes the present invention may be applied in may be mentioned for example fiber suspension flows of paper and pulp mills, thickening processes of various sludges, recycled fiber processes, bleaching processes and in general processes where feeding of a chemical separate from another chemical having an opposite electric charge into filtrate, fiber suspension, sludge or the like is needed.

The injection mixing apparatus according to the present invention allows using as the feeding/injection liquid with which a chemical is supplied into the process liquid, for example into fiber suspension, the same fiber suspension into which the chemical is to be fed. Of course also more dilute (fibrous or other) suspensions, various filtrates or corresponding turbid liquids or mere fresh water may be used as the feeding/injection liquid in the injection mixing apparatus of the invention. In a similar manner the mixing liquid used sometimes in the injection mixing apparatus may be any liquid from the process itself or even fresh water. Thus all the liquid obtained from another process stage that can be used in the injection feeding or mixing of the chemical/s, saves fresh water and thus, for example, reduces the consumption of fresh water at the mill.

Other advantages gained by the use of the present invention are, for instance,
decreased consumption of chemicals, as the chemicals are kept apart such that they do not neutralize each other
reduced need of feeding equipment, as now a single injection mixer, or a single injection mixing station is used to inject the chemicals having opposite electric charges.
reduced space needed in the process piping, as there is no need to arrange the first chemical time to be mixed with the process liquid upstream of the second mixer.

Other characteristic features of the method and the injection mixing apparatus of the present invention are disclosed in the appended patent claims.

### BRIEF DESCRIPTION OF DRAWING

In the following, the method and the apparatus of the present invention are discussed in more detail with reference to the appended figures, in which

FIG. 1 illustrates a prior art injection mixing apparatus;

FIG. 2 illustrates a injection mixing apparatus in accordance with a first preferred embodiment of the present invention;

FIG. 3 illustrates the operation of the injection mixing apparatus of FIG. 2;

FIG. 4 illustrates a injection mixing apparatus in accordance with a variation of the first preferred embodiment of the present invention;

FIG. 5 illustrates the operation of the injection mixing apparatus of FIG. 4;

FIG. 6 illustrates the operation of an injection mixing station applying the injection mixing apparatuses of FIG. 4; and

FIG. 7 illustrates an injection mixing apparatus in accordance with a second preferred embodiment of the present invention.

### DETAILED DESCRIPTION OF DRAWINGS

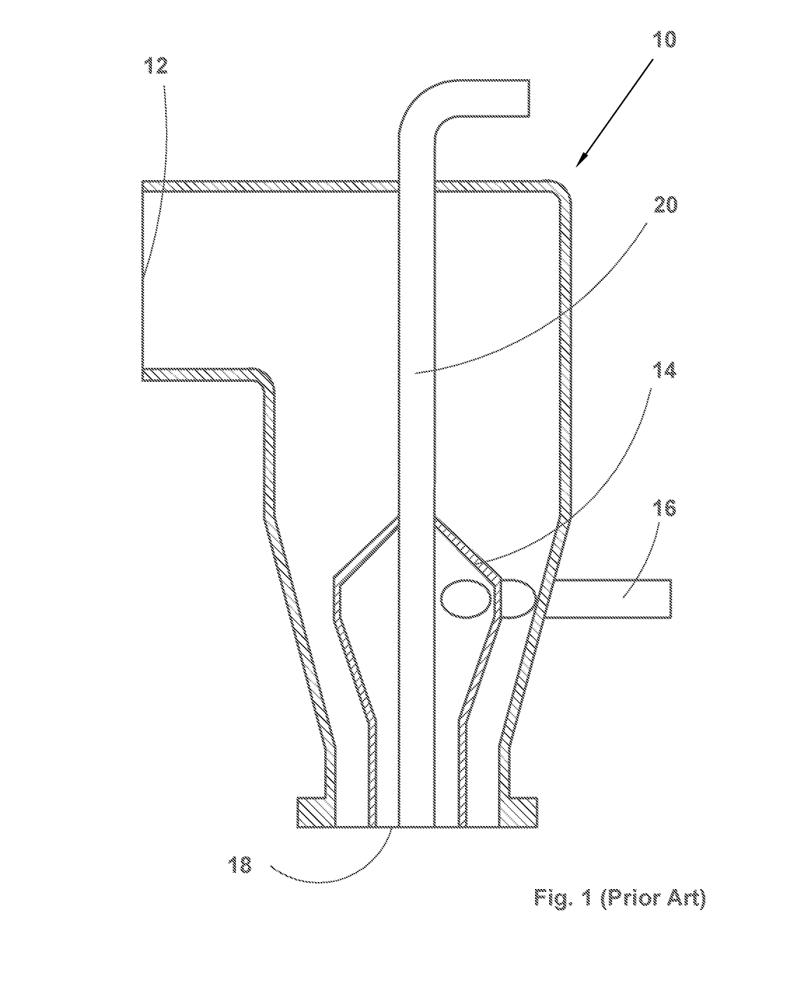

FIG. 1 illustrates a prior art mixing apparatus discussed, for instance, in WO-A1-2006008333. The mixing apparatus 10 of FIG. 1 has an inlet 12 for a feeding/injection liquid and a centrally disposed hollow member 14 into which a chemical is supplied via the conduit 16. At the lower end of the member 12 there is preferably an annular opening 18, via which the retention chemical is allowed to be discharged into a fiber suspension. Thus the mixing of the chemical with the feeding liquid takes place essentially at the same time as the chemical is fed into the process liquid flow. In addition to the conduit 16 introducing the chemical, the mixing apparatus is provided with an inner axial pipe 20 running through the hollow member 14 and terminating at the annular opening 18. The axial pipe 20 may be used to introduce a so-called mixing liquid into the process liquid e.g. either clean water, circulation water from the paper mill, white water, clear filtrate or some other non-clean turbid liquid. The mixing liquid is discharged to the chemical to be fed essentially at the same time as the chemical is discharged to the feed liquid and further to the pulp flow. It is also possible, if it is desirable to use the mixing liquid to dilute the chemical, to arrange the inner pipe 20 to end at a distance from the opening 18 whereby the mixing liquid has some time to dilute the chemical prior to its injection into the process liquid by means of the feeding liquid. The prior art document teaches that it is possible to introduce via the inner pipe 20 another chemical, if desired, especially in case of a retention chemical containing several components. As an example, a short-chained retention chemical may be mentioned, in case the retention chemical is formed of a long-chained and a short-chained chemical. In that case, the long-chained chemical is supplied tangentially into the member 14 through the conduit 16, and the short-chained along pipe 20. Another option discussed in the prior art WO document is to mix the second, and possibly third, chemical with the mixing liquid or with the feeding liquid upstream of the mixing apparatus. In both cases, the mixing of the chemical/s into the fiber suspension or process liquid takes place by means of the feeding liquid injected from the mixing apparatus into the process liquid flow. Thus, all three injections take place in the same direction and simultaneously such that the chemicals are able to meet immediately after the injection without having a proper chance to be diluted, i.e. to have their concentration reduced, within the process liquid.

The above discussed mixing apparatus or injection mixer works well when the chemicals that are to be introduced into the process liquid are such that they react with the solids, or with each other relatively slowly, whereby they are allowed to contact either each other or the solids in the mixing or feeding liquid prior to their proper mixing into the process liquid. In such a case the chemicals do not react with each other or do not affect each other or the process liquid or possible solids in the process liquid in a negative manner. In an opposite case the contact of the chemicals result in at least one of waste of chemical/s, deterioration of the chemical, the process liquid or one or more of its components, problems in the manufacture of the end product, waste of process liquid etc.. A few problems have been discussed in more detail already above.

Thus the present invention concentrates on a novel injection mixing apparatus and a novel method of injecting chemicals having opposite electric charges into a process liquid. The mixer and the method in accordance with the present invention are designed to keep the chemicals having opposite electric charges apart such that a first chemical is mixed, to a sufficient degree, with a feeding liquid and the mixture of the first chemical and the feeding liquid are injected and mixed in the process liquid, whereby the concentration of the discharged first chemical reduces rapidly. At the same time the second chemical having an opposite electric charge compared to the first chemical is injected into the process liquid by means of injection opening/s at a radial (in relation to the process liquid flow duct) distance from the injection opening/s of the mixture of the first chemical and the feeding liquid. By means of the above approach the chemical molecules or ions of the first and second chemical have a significantly reduced likelihood of getting into contact with one another before contacting any solid in the process liquid. Naturally, the same function could be arranged by providing two injection mixers, or two mixing stations (formed of one or more mixers on the same circumference of a pipe), at an axial distance from each other on the wall of the process liquid flow pipe such that a first mixer/mixing station introduces and mixes the first chemical and the second mixer/mixing station the second chemical. However, both providing the process liquid flow pipe with a new opening/set of openings for the mixer/mixing station for the second chemical, and the mixer/mixing station itself increase considerably the expenses involved in feeding an additional chemical.

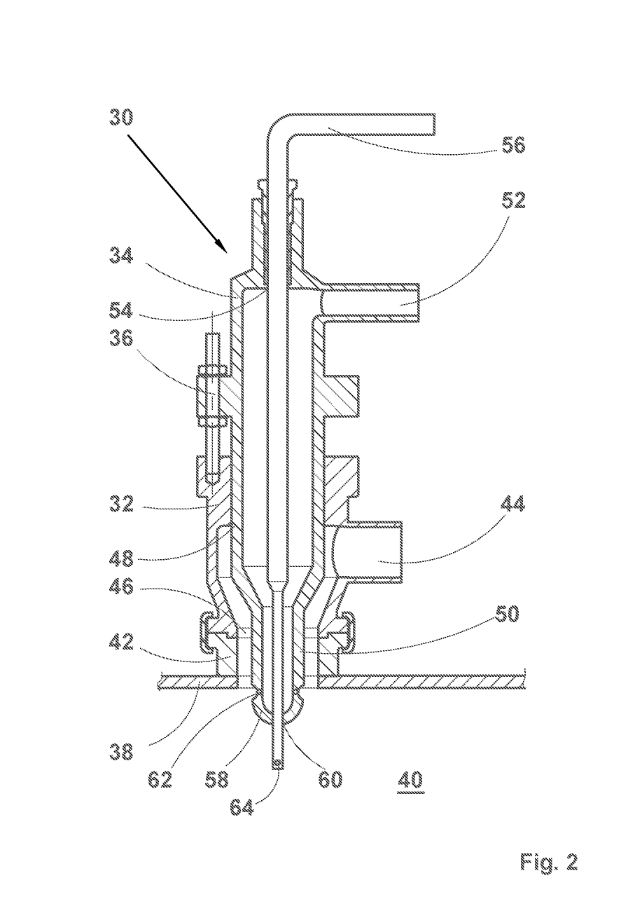

In the following FIGS. 2-7 various embodiments of the present invention are discussed in more detail.

FIG. 2 illustrates an injection mixer 30 in accordance with a first preferred embodiment of the present invention. The injection mixer 30 of FIG. 2 comprises a first casing 32, a second casing 34 and a conduit 56 for the second chemical. The first and the second casing are fastened to each other by means of, for instance, bolts 36. The injection mixer 30 is fastened to the wall 38 of the process liquid flow pipe 40 by its first casing 32, for instance, by means of an intermediate sleeve 42. The first casing 32 has an inlet 44 for an injection or feeding liquid, which may be either clean water or almost any non-clean liquid that may be introduced into the process liquid, and an outlet 46 via which the injection liquid is introduced (first into the sleeve, and then) into the process liquid flow pipe 40. The opposite end, i.e. the second end of the first casing 32 is provided with a preferably round opening 48 through which the second casing 34 extends into the first casing 32. The first or inner end 50 of the second casing 34 extends through the first casing 32 inside the sleeve 42 such that the flow path (functions as an extension of the outlet 46) of the injection liquid between the sleeve 42 and the first end 50 of the second casing 34 is preferably annular.

The second or outer end of the second casing 34 is provided with an inlet 52 for a first chemical, and a preferably axial opening 54 for the conduit 56 for the second chemical having an opposite electric charge compared to the first chemical. The conduit 56 extends preferably axially though the second casing 34 leaving an annular flow passage between the conduit 56 and the second casing 34 for the first chemical. The conduit 56 is connected at its end farther away from the process liquid flow pipe 40 to a source of a second chemical. The first or inner end 50 of the second casing 34 is provided with a cap 58 having a central opening 60 for the conduit 56. In accordance with a preferred (but not necessary) variation of the present invention the inner end 50 of the second casing 34 extends through the sleeve 42 such that the cap 58 is positioned substantially at the level of the inner surface of the wall 38 of the flow pipe 40. The cap 58 or the interface between the cap 58 and the cylindrical first end 50 of the second casing 34 is provided with holes 62 for injecting the first chemical in more or less radial direction (in view of the second casing 34) into the annular flow path between the sleeve 42 and the second casing 34 in other words into an annular or fan-shaped jet of injection liquid entering the flow pipe 40 from the annular flow path between the second casing 34 and the sleeve 42. However, as the purpose of the holes and the injection of the first chemical is to mix and to dilute, or to reduce the concentration of, the first chemical within the injection liquid, the first chemical may be injected from the injection holes 62 having their axis from substantially radial (in relation to the second casing 34) direction to a direction almost against the injection liquid flow. By substantially radial direction in relation to the second casing are here understood directions deviating at most 45 degrees of the radial direction. The substantially radial direction may also be called transverse direction, whereby the direction of the axis of the holes 62 deviates at least ±1-45 degrees from the direction of the longitudinal axis of the mixing apparatus or injection mixer. Naturally, the direction depends also on the speed of injection of the first chemical compared to that of the injection liquid flow or the pressure difference between the first chemical and the injection liquid. The lower the speed or pressure difference is the more radial the injection of the first chemical should be, or possibly directed against the injection liquid flow. In other words, all such directions of the chemical jet are applicable, which result in efficient mixing of the first chemical into the injection liquid. Also, it should be understood that the axial positioning of the second casing 34 in relation to the first casing 32 may be adjusted such that the mixing holes 62 of the second casing may be facing anything between the lower or inner end (the end where the conical part terminates) of the first casing and the open process liquid flow pipe 40 just inside the wall 38 of the flow pipe 40.

The conduit 56 for the second chemical having an opposite electric charge extends through the opening 60 in the cap 58 into the flow pipe 40, preferably, but not necessarily, towards the center thereof. The conduit 56 has one or more injection holes 64 for the second chemical at least at the end of the conduit 56 such that the distance from the mixing of the first chemical to the feeding liquid (i.e. the distance from the injection holes 62) to the injection holes 64 at the end of the conduit 56 is of the order of 20 . . . 500 mm, preferably 150-500 mm, or 2% . . . 40%, preferably 15-40% of the diameter of the process liquid flow pipe (both definitions depending on the diameter of the process liquid flow pipe). The injection of the second chemical having an opposite electric charge from the conduit 56 may take place not only via several injection holes 64, as discussed above, but also from a single hole or opening at the end of the conduit 56.

The most remarkable differences between the method and the apparatus of the present invention and the earlier discussed prior art mixing methods and injection mixers may be seen in both the structure and the operation of the injection mixer. In the present invention the conduit 56 for the second chemical having an opposite electric charge is extending inside the process liquid flow pipe 40 such that it allows the mixing of the injection liquid with the first chemical and feeding of the mixture thereof well before the injection of the second chemical into the process liquid. Thus the first chemical has some time to, for instance, adhere to or initiate a chemical or other reaction with the solids in the injection liquid and the process liquid it has been introduced in, until the second chemical having an opposite electric charge is injected and thus allowed to get into contact with the mixture of the first chemical, feeding liquid and the process liquid and/or the solids therein.

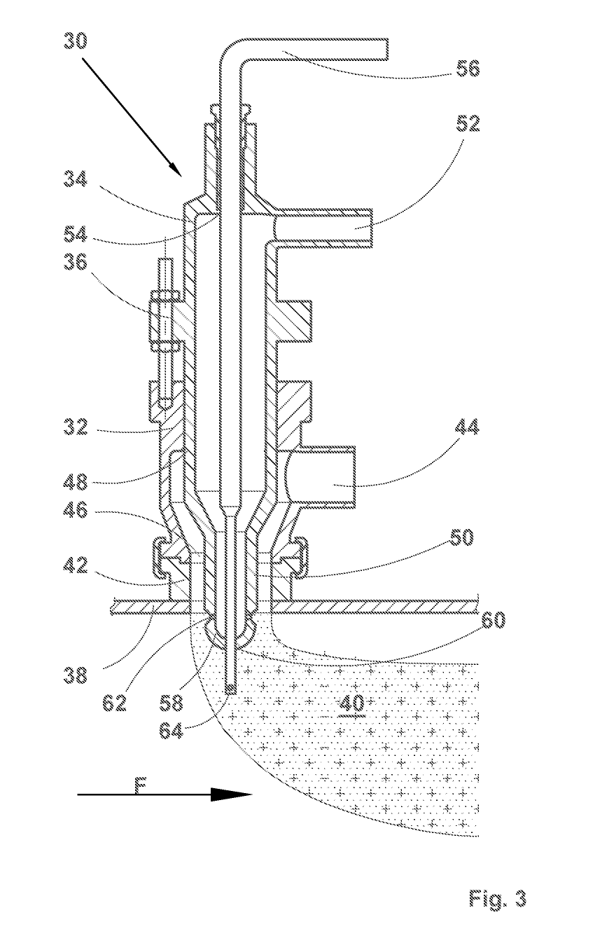

FIG. 3 illustrates the function of the injection mixer 30 of FIG. 2. The dotted area shows the mixture of the first chemical, i.e. the chemical that has been injected into the feeding liquid via the injection holes 62 and thereby been mixed therewith, and the injection liquid injected into the process liquid flow. The crossed area shows the second chemical having an opposite electric charge injected via the injection hole/s 64 at the end part of the conduit 56 into the process liquid, and into the jet of the above discussed mixture. The second chemical is preferably, but not necessarily, injected into the flow pipe 40 such that the second chemical spreads to the cross section of the jet of the injected mixture of the first chemical and the injection liquid. In such a case the injection liquid aids in mixing the second chemical with the process liquid, too. Arrow F shows the flow direction of the process liquid.

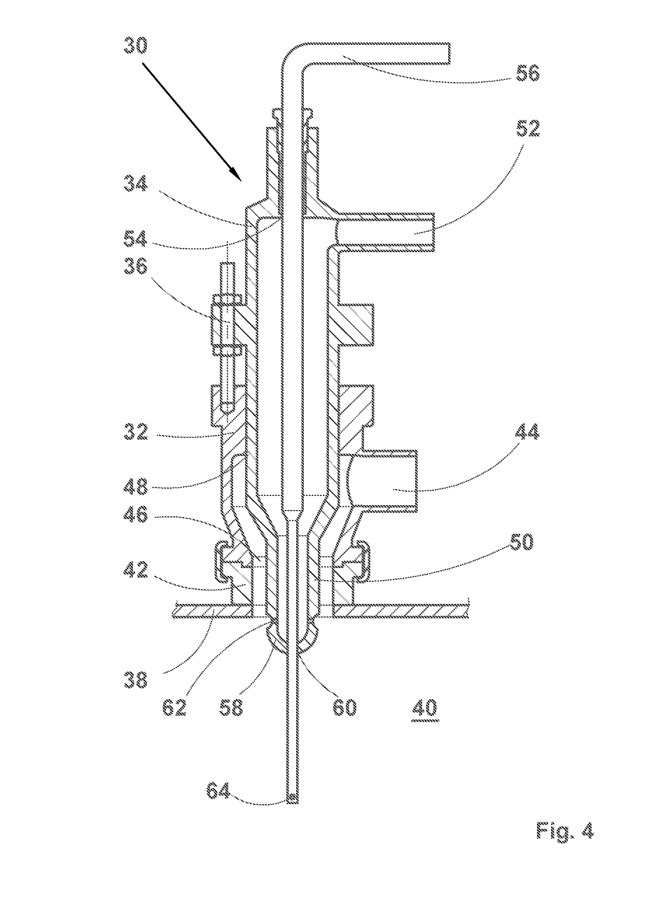

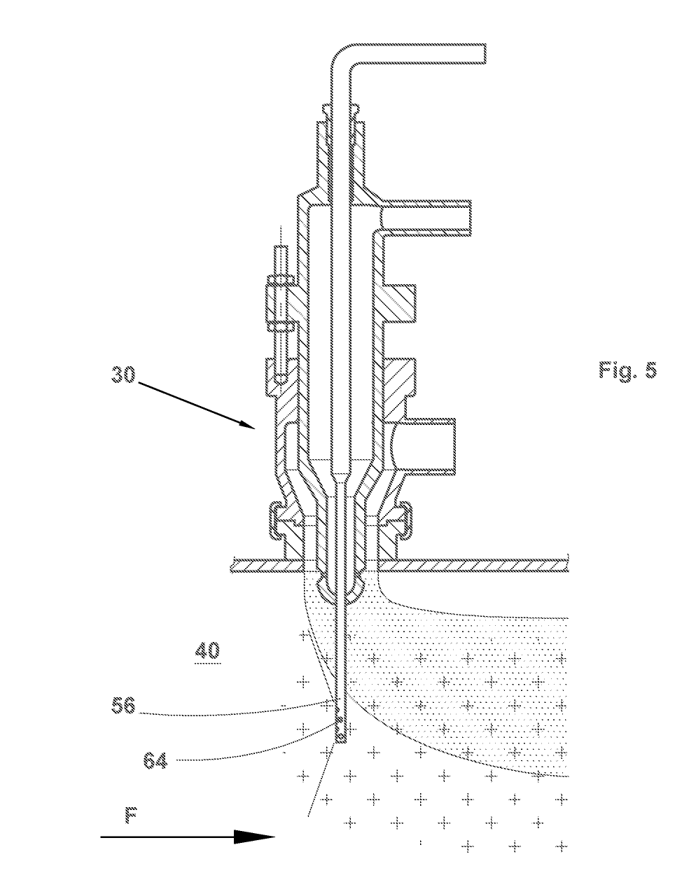

FIGS. 4 and 5 illustrate a variation of the first preferred embodiment of the injection mixer of FIGS. 2 and 3 and its function. Thus the basic structure of the injection mixer is the same as well as the reference numerals. In this variation the conduit 56 for the second chemical extends deeper into the process liquid flow pipe 40 such that the one or more injection openings 64 for the second chemical having an opposite electric charge are outside the jet formed of the mixture of the first chemical and the feeding liquid. The dotted area in FIG. 5 shows the injection liquid jet in which the first chemical is mixed substantially evenly, i.e. in the manner discussed in connection with FIGS. 2 and 3. The crossed area shows the mixed second chemical having an opposite electric charge i.e. the chemical that has been injected by means of an elevated pressure via the injection holes/openings 64 into the process liquid flow. The injection hole/s 64 are preferably, but not necessarily, arranged such that they inject the second chemical against the process liquid flow, and at such an angle that the second chemical is spread to a substantial area of the cross-section of the flow pipe 40 before entering the jet of the mixture of the first chemical and the injection liquid. Arrow F shows the flow direction of the process liquid. Naturally another option is to discharge the second chemical having an opposite electric charge into the process liquid flow from one opening located at the end of the conduit 56.

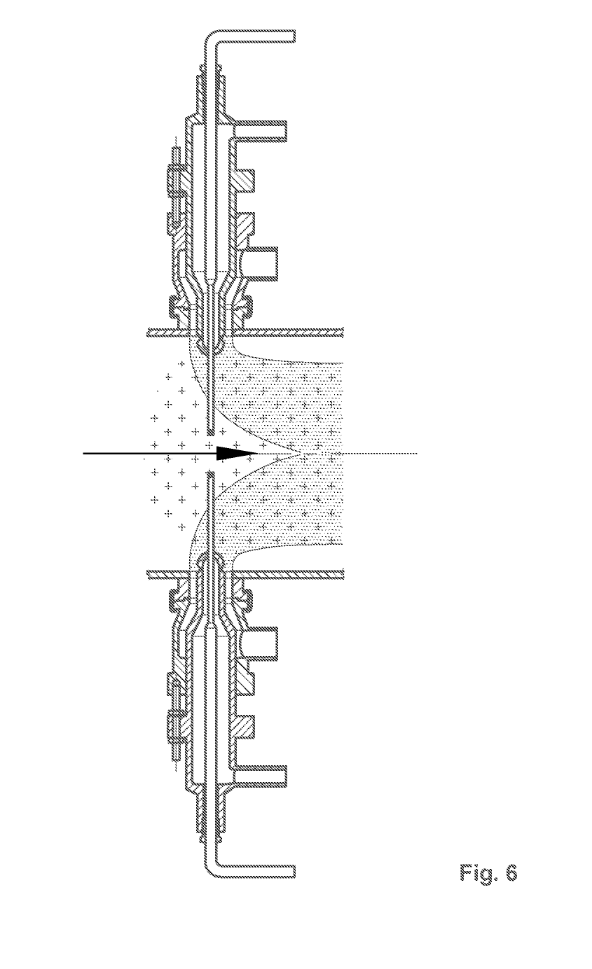

FIG. 6 illustrates a practical example of the use of an injection mixing station, i.e. the use of one or more injection mixers of the present invention (2 mixers of FIG. 4 shown here). When the process liquid flows in a pipe having a considerable diameter it has been learned that an injection mixing station having several injection mixers is normally required. When using a substantially small process liquid flow pipe two injection mixers arranged on the same pipe diameter opposite to each other is sufficient, whereby the operation of the mixers is the one shown in FIG. 6. This means that the injection jets of an injection mixer extend at least up to about the centerline of the pipe or somewhat farther. Thus the jets of the opposite mixers meet and cover substantially the entire cross-section of the flow pipe. Near the pipe surface, the surface friction and the turbulence created thereby take care of the efficient mixing of the process liquid with the chemicals in a few meters' distance. In a similar manner the jets of the second chemical from their feed openings meet at the center of the pipe and cover a substantial share of the cross section of the flow pipe.

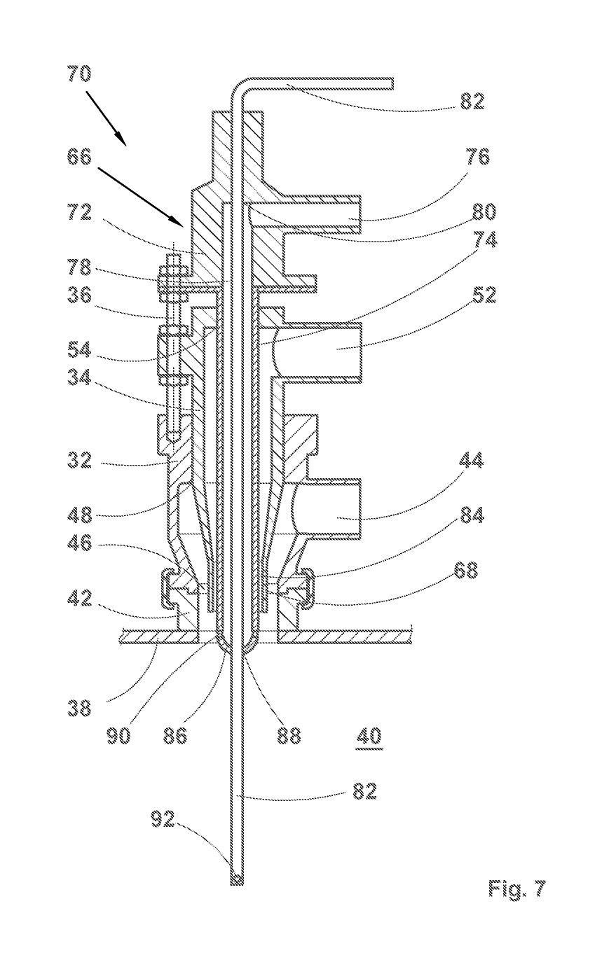

FIG. 7 illustrates an injection mixer in accordance with a second preferred embodiment of the present invention. The injection mixer 70 of FIG. 7 comprises a first casing 32, a second casing 34, a third casing 66 and a conduit 82 for the second chemical. The first, second and third casings are fastened to each other by means of, for instance, bolts 36. The injection mixer 30 is fastened to the wall 38 of the process liquid flow pipe 40 by its first casing 32, for instance, by means of an intermediate sleeve 42. The first casing 32 has an inlet 44 for an injection liquid, which may be either clean water or almost any non-clean liquid that may be introduced into the process liquid, and an outlet 46 via which the injection liquid is introduced into the process liquid flow pipe 40. The opposite end, i.e. the second end of the first casing 32 is provided with a preferably round opening 48 into which a second casing 34 is installed. The first or inner end 68 of the second casing 34 extends through the first casing 32 down to the sleeve 42 such that the outlet 46 and the flow path of the injection liquid between the sleeve 42 and the first end 68 of the second casing 34 is preferably annular. The inner end 68 of the second casing 34 terminates preferably within the sleeve 42 though it may extend up to the wall 38 of the flow pipe 40. It should be understood here that the first casing 32 is fastened to the wall 38 of the process liquid flow pipe in a manner similar to the embodiment of FIGS. 2-6. In the earlier embodiment the longitudinal position of the second casing 34 was adjustable within the first casing 32. The same applies here, too. Thus the position of the end part of the second casing 34 may be longitudinally adjusted between the conical part of the first casing 32 and the inside of the process liquid flow pipe 40. Additionally, the longitudinal, i.e. axial position of the third casing 66 is, preferably, adjustable, too. It means that, for instance, the position of the third casing within the second casing may be adjusted.

The second or outer end of the second casing 34 is provided with an inlet 52 for a first chemical, and a preferably axial opening 54 for the third casing 66. The third casing 66 comprises a casing body 72 and a mixing liquid conduit 74. The casing body 72 has an inlet 76 for the mixing liquid, an outlet opening 78 communicating with the mixing liquid conduit 74, and an opening 80 for a conduit 82 for a second chemical having an opposite electric charge. The conduit 74 for the mixing liquid extends preferably axially though the second casing 34 leaving an annular flow passage for the first chemical between the conduit 74 and the second casing 34. The first or inner end 68 of the second casing 34 and the conduit 74 leave an annular outlet opening 84 via which the first chemical is introduced into the injection liquid flow. The mixing liquid conduit 74 terminates to a cap 86, which is provided with a central opening 88 via which the conduit 82 for the second chemical having an opposite electric charge passes into the flow pipe 40. The cap 86 or the interface between the cap 86 and the cylindrical inner end of the mixing liquid conduit 74 is provided with holes 90 for injecting the mixing liquid into the annular or fan-shaped jet or flow of injection liquid and the first chemical entering the flow pipe 40 along the annular passage between the mixing liquid conduit 74 and the sleeve 42. The mixing liquid mixes efficiently the first chemical with the injection liquid. Thus the mixing liquid may be injected from the holes 90 having their axis from substantially radial direction (in relation to the mixing liquid conduit 74) to a direction almost against the injection liquid flow, i.e. the direction of the axis of the holes is transverse to the direction of the longitudinal axis of the injection mixer. In other words, in designing the holes 90 principles similar to holes 62 in FIG. 2 may be applied. The holes 90 are positioned, in the axial or longitudinal direction of the injection mixer 70, in a desired position between the end 68 of the second conduit and the end cap 86. The conduit 82 extends through the opening 88 in the cap 86 into the flow pipe 40. The conduit 82 has one or more injection holes 92 for the second chemical at least at the end of the conduit 82 such that the distance from the wall 38 of the flow pipe 40, or from the mixing of the first chemical to the feeding liquid, to the injection hole/s 92 is of the order of 30 . . . 500 mm, preferably 150-500 mm, or 2% . . . 40%, preferably 15-40%, of the diameter of the process liquid flow pipe 40.

It should also be understood that the flow path of the first chemical to the injection liquid may be not only annular and parallel with the flow path 46 of the injection liquid but the first end 68 of the second casing 32 may have more or less transverse opening via which the first chemical enters the injection liquid flow. Also it should be realized that the efficiency of the mixing of the first chemical with the injection liquid by means of the mixing liquid may be controlled by adjusting the distance between the end 68 of the second casing 34 from the mixing holes 90 of the third casing 66. This may be performed by adjusting the longitudinal position of the third casing 66 in relation to the second casing 34.

As to the length of the conduit 82 for the second chemical having an opposite electric charge, it may extend as deep into the process liquid flow pipe 40 as the respective conduit 56 of the first embodiment. In other words, the injection hole/s 92 may be located either inside or outside the jet of the mixture of the first chemical, the mixing liquid and the injection liquid. Also, it should be understood that the length or the extension of the conduit 56 (in the embodiment of FIGS. 2-6) or conduit 82 for the second chemical having an opposite electric charge inside the process liquid flow pipe 40 may be made adjustable.

Especially, in connection with the embodiments where the conduit (56 and 82) of the second chemical having an opposite electric charge extends outside the jet of the first chemical and the injection liquid (and the mixing liquid) it is advantageous to inject the second chemical such that it spreads efficiently to as wide a cross section of the process liquid flow pipe as possible. When doing so the second chemical is, in a way, first introduced into the process liquid flow, i.e. before the first chemical is introduced therein by means of the injection liquid. In other words, the more evenly and uniformly the second chemical having an opposite electric charge is mixed with the process liquid prior to contact with the mixture of the mixing liquid, the injection liquid and the first chemical, the more efficiently the second chemical is used and the more uniform is the effect of the second chemical throughout the process liquid flow. Not to mention that the risk of the chemicals having opposite electric charges getting into direct contact with and possibly bonding to each other is also efficiently avoided. Therefore it is advantageous to design the ends, or the lengths of the conduits 56 and 82 used for injecting the second chemical having an opposite electric charge such that the second chemical is injected in all radial directions, and preferably, but not necessarily, more or less against the flow of the process liquid.

As to the chemicals that may be introduced into a process liquid, in this example into a paper making stock, the following chemical pairs may be mentioned:
anionic chemical and cationic chemical,
anionic polymer and cationic polymer,
cationic polymer and anionic micro polymer,
cationic polymer and anionic bentonite,
cationic polymer and anionic nanoparticles, and
cationic polymer and anionic silicate.
   Additionally, there are numerous chemicals, like for instance, filler, retention chemical, sizing agent e.g. AKD or ASA, starch, opacity pigment, resin, alum, paper dye, fixative, NaOH, defoaming agent, optical brightener, micro- or nanofiber, etc. which have an electric charge, whereby the invention covers also feeding of any such pair of chemicals that the chemicals have opposite electric charges.

Naturally it is clear that the method and the apparatus of the present invention do not limit by any means the type of chemicals that are to be introduced. Thus the chemicals may be gaseous or liquid chemicals needed in the process the method and the apparatus are applied for.

As may be seen from the above, a novel method and an apparatus for mixing various chemicals having opposite electric charges to a process liquid flow has been developed. It should be noted that although the above description generally discusses the use of the injection feeder or the injection mixing apparatus according to the invention particularly in connection with applications in wood processing industry the invention may be applied anywhere chemicals need to be fed and mixed into a medium flow evenly and in precise amounts. Thus, the field of application and the scope of protection of the invention are defined by the appended patent claims, only. Also, it should be realized that the word “chemical” is understood in a broad sense, i.e. it covers each and every additive, treatment agent, filler, pigment etc. having an electric charge and being introduced in the process liquid for treating the process liquid or for changing its properties or the properties of an intermediate or end product.

1.-20. (canceled)

21. A method of mixing chemicals having opposite electric charges into a process liquid flowing in a process liquid flow pipe comprising:
introducing a first chemical to a first passage of a mixing apparatus attached to the process liquid flow pipe;
introducing an injection liquid into a second passage of the mixing apparatus, wherein the second passage includes an outlet proximate to an opening in the process liquid flow pipe;
introducing to a third passage of the mixing apparatus a second chemical having an electrical charge opposite to the electric charge of the first chemical;
injecting the first chemical into the injection liquid by passing the first chemical through a passage between the first passage and the second passage, whereby the injection forms a mixture of the first chemical and the injection liquid;
introducing the mixture of the first chemical and the injection liquid to a process liquid flowing through the process liquid flow pipe such that the mixture mixes with the process liquid and a concentration of the first chemical is diluted by the process liquid, and
introducing the second chemical from the third passage to the process liquid in the process liquid flow pipe, wherein the second chemical passes from the third passage to the process liquid a distance from the injection of the first chemical into the injection liquid.

22. The method of claim 21 wherein the second chemical passes into the process liquid flow separately from the injection of the first chemical into the injection liquid.

23. The method of claim 21 wherein the injection of the first chemical includes jetting the first chemical into the injection liquid flow in a direction transverse to a flow of the injection liquid flow through the second passage.

24. The method of claim 21 wherein the injection of the first chemical includes injecting the first chemical into the injection liquid flow before the first chemical mixes with the process liquid.

25. The method of claim 21 wherein the introduction of the second chemical into the process liquid flow occurs within a jet formed of the first chemical and the injection liquid.

26. The method of claim 21 wherein the introduction of the second chemical to the process liquid upstream in the process liquid flow of a jet formed in the process liquid flow by the first chemical and the injection liquid.

27. The method of claim 21 wherein the injection of the second chemical is in a direction against a flow direction of the process liquid flow in the process liquid flow pipe.

28. A mixing apparatus for mixing at least two chemicals having opposite electric charges in a process liquid flowing in a process liquid flow pipe, the apparatus comprising:
a mixer casing including a first inlet and first passage for a first chemical, a second inlet and second passage for an injection liquid, and a third inlet and third passage for a second chemical having an opposite electric charge to the first chemical, and
the mixer casing coupled to a wall of the process liquid flow pipe such that an outlet to the second passage is open to a process liquid flow passage in the process liquid flow pipe;
a passage between the first passage and the second passage for introducing the first chemical into the injection liquid to form a mixture of the first chemical and the injection liquid; and
the third passage includes a conduit extending into the process liquid flow pipe and beyond the distal ends of the first and second passages, wherein the conduit includes an outlet for injecting the second chemical into the process liquid flow.

29. The mixing apparatus as recited in claim 28, wherein a distal region of the conduit includes an injection hole for the second chemical.

30. The mixing apparatus as recited in claim 29, wherein the conduit projects radially inwardly from the wall into the process liquid flow pipe and a distal end region of the conduit includes an injection hole for the second chemical.

31. The mixing apparatus as recited in claim 28, wherein the first passage extends within the second passage and along the longitudinal axis of the second passage, and the third passage extends along the longitudinal axis and is within and extends beyond the first passage.

32. The mixing apparatus as recited in claim 28, wherein the passage between the first and second passages is proximate the wall of the process liquid flow pipe.

33. The mixing apparatus as recited in claim 28 wherein the passage between the first and second passage is in a cap at the end of the first passage or at an interface between the cap and a remaining portion of the first passage.

34. The mixing apparatus as recited in claim 28 wherein the mixer casing includes a sleeve which provides the coupling to a wall of the process liquid flow pipe.

35. The mixing apparatus as recited in claim 31 wherein the passage between the first and second passage is in a cap at the end of the first passage or at an interface between the cap and a remaining portion of the first passage.

36. The mixing apparatus as recited in claim 34 further comprising a second mixer casing extending inside or through the sleeve.

37. The mixing apparatus as recited in claim 36 wherein a third mixer casing extends inside or through the sleeve.

38. The mixing apparatus as recited in claim 28, wherein the outlet to the third passage is a distance in a range of 20 to 500 mm from the wall of the process flow pipe.

39. A method to mix chemicals into a process flow comprising:
introducing a first chemical to a first passage of a mixing apparatus attached to a process liquid flow pipe;
introducing an injection liquid into a second passage of the mixing apparatus;
introducing to a third passage of the mixing apparatus a second chemical having an electrical charge opposite to the electric charge of the first chemical;
injecting the first chemical into the injection liquid by passing the first chemical through a passage between the first passage and the second passage;
introducing the mixture of the first chemical and the injection liquid to a process liquid flowing through the process liquid flow pipe, and introducing the second chemical from the third passage to the process liquid in the process liquid flow pipe, wherein the second chemical passes from the third passage into a region of the process liquid upstream of a jet in the process liquid formed by the mixture of the first chemical and the injection liquid.
